(19) United States
(12) Patent Application Publication
(10) Pub. No.: US 2009/0127921 A1
(43) Pub. Date: May 21, 2009

(54) PROCESS FOR THE PRODUCTION OF CELLULAR POLYURETHANE (PUR) CASTING ELASTOMERS FROM STORAGE-STABLE 1,5-NAPHTHALENEDIISOCYANATE (NDI) PREPOLYMERS

(75) Inventor: Jens Krause, Koeln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/271,210

(22) Filed: Nov. 14, 2008

(30) Foreign Application Priority Data
Nov. 17, 2007 (DE) 102007054983.2

(51) Int. Cl. B60B 11/10; B32B 5/20; B29C 67/20

(52) U.S. Cl. 301/38.1; 264/41; 428/160

(57) ABSTRACT

The present invention relates to a process for the production of cellular polyurethane (PUR) casting elastomers and moulded articles based on 1,5-naphthalenediisocyanate (NDI)-prepolymers.

### RELATED APPLICATIONS

This application claims benefit to German Patent Application No. 10 2007 054 983.2, filed Nov. 17, 2007, which is incorporated herein by reference in its entirety for all useful purposes.

### BACKGROUND OF THE INVENTION

The present invention relates to a process for the production of cellular polyurethane (PUR) casting elastomers and moulded articles based on 1,5-naphthalenediisocyanate (NDI) prepolymers.

Cellular, for example microcellular, polyisocyanate polyaddition products, normally polyurethanes (PUR) and/or polyisocyanurates, obtainable by reacting isocyanates with compounds reactive to isocyanates, as well as processes for their production are generally known. A particular form of these products are cellular, in particular microcellular, polyurethane elastomers, which differ from conventional polyurethane foamed materials by their substantially higher density of 300 to 600 kg/m³, their special physical properties, and the application possibilities thereby presented (Günter Oertel, 3^{rd} Newly Revised Edition, Becker/Braun Kunstoff Handbuch 7, Hanser Verlag, pp. 378 to 381 (Chapter 7.3.3.2) as well as p. 428). Such polyurethane elastomers are used for example as vibration-damping and impact-damping elements, in particular in automobile manufacture. The springy and resilient elements produced from polyurethane elastomers are slipped onto the piston rod of the shock absorber in automobiles, for example in the overall shock absorber assembly consisting of shock absorber, flat coil spring and elastomer spring. One of the most important requirements is to achieve excellent dynamic-mechanical and static-mechanical properties, for example outstanding tensile strength, elongation, crack propagation resistance and compression set, so that the polyurethane elastomers can satisfy over as long a period as possible the high mechanical requirements that are placed on the damping elements. Cellular polyisocyanate polyaddition products are produced in a casting mould. In order to meet the extremely high dynamic and mechanical requirements, cellular polyurethane elastomers based on 1,5-NDI have been produced for some years (DE-A 29 40 856). A disadvantage of the known processes is that 1,5-NDI-based prepolymers have only a limited storage stability. Such prepolymers therefore cannot be stored and have to be prepared in situ and converted directly to the elastomer.

Commercially NDI-based PURs exist exclusively as non storage-stable prepolymers (DE-A 195 34 163). For example, the NHI available in chip or flake form requires a comparatively complicated continuous metering of solids in order to ensure that a continuously produced NCO prepolymer with a constant NCO value and constant composition is obtained. Furthermore, work health and safety aspects arising from the comparatively high tendency of NDI to undergo sublimation require an increased technical expenditure. One way of avoiding this problem is to use an NDI prepolymer prepared beforehand, which would have to be homogeneous as regards its structure. From the group of NDI prepolymers only those can be used however that have a sufficient storage stability. Conventional NDI prepolymers, such as are used on a large scale to produce NDI casting elastomers, are characterised by the fact that under storage conditions, for example at temperatures below 50° C., the unreacted monomeric NDI precipitates out on account of its low solubility and high melting point. Simply heating to temperatures above the melting point of NDI (127° C.) is however not satisfactory for the following reasons. The high temperature stress associated with the melting procedure leads to secondary reactions and ultimately to a drop in the NCO characteristic number, connected with an increase in the viscosity, with the result that a simple working-up becomes at the very least complicated, if not impossible. The problem in this case is in particular the fact that the ratio of NCO groups to Zerewitinoff-active hydrogen atoms (“NCO characteristic number”) changes very markedly, leading to non-uniform compounds. Specifically with low NCO contents of NDI prepolymers (2.5-6 wt. % NCO), with which nevertheless the technically relevant hardness range of PU elastomers can be covered, any deviation has a very marked influence on the characteristic number and thus ultimately on the processing properties and material properties. Storing an NDI prepolymer at high temperature, for example above 120° C., is just as impracticable a solution, since under these conditions, despite the fact that the free monomeric NDI is prevented from crystallising out, nevertheless secondary reactions lead to a rapid rise in viscosity, and moreover the properties of casting elastomers produced therefrom are drastically impaired.

The aforementioned problems of conventional, non-storage stable NDI prepolymers are the background to processing recommendations that state that the chain extension reaction should be carried out within 30 minutes after production of the NDI prepolymer, and to descriptions in the literature that in general cast doubt on the storage stability of NDI prepolymers: thus, it is stated in “Solid Polyurethane Elastomers, P. Wright and A. P. C. Cummings, Maclaren and Sons, London 1969, pp. 104 ff. in Chapter 6.2. as follows:

“6.2.1. Unstable Prepolymer Systems (Vulkollan) (Vulkollan®; Trade name for casting elastomers based on naphthalenediisocyanate (NDI) from Bayer MaterialScience AG).

Vulkollan is manufactured by a prepolymer route, although the prepolymer is non-storable and must be further reacted within a short interval of time. The prepolymer so formed is relatively unstable since further undesirable side reactions can take place. To reduce the possibility of these side reactions occurring, the next stage in the process, viz. the chain extension, should take place as soon as possible but within a maximum of 30 minutes.”

The object of the invention was therefore to provide cellular PUR casting elastomers and cast moulded articles with improved CS (compression set) and with the known advantageous material properties of NDI casting elastomers, and to develop a technically advantageous implementable process for their production.

It was surprisingly found that cellular PUR casting elastomers based on NDI can be produced by reacting special, storage-stable NDI-based NCO prepolymers with cross-linking agents.

### EMBODIMENTS OF THE INVENTION

An embodiment of the present invention is a process for producing cellular polyurethane casting elastomers, comprising
A) reacting 1,5-naphthalenediisocyanate (NDI) with a polyol having a number average molecular weight in the range of from 850 to 3000 g/mole, a viscosity of less than 1500 mPas measured at 75° C., and a functionality in the range of from 1.95 to 2.15, and is selected from the group consisting of polyester polyols, poly-ε-caprolactone-polyols, polycarbonate polyols, polyether polyols, and α-hydro-ω-hydroxy-poly(oxytetramethylene) polyols, in a ratio of NCO groups to OH groups of from 1.55:1 to 2.35:1, continuously or discontinuously at a temperature in the range of from 80° C. to 240° C., optionally in the presence of auxiliary substances and additives, to form a storage-stable NCO prepolymer with an NCO content in the range of from 2.5 to 6 weight % and a viscosity of less than 5000 mPas measured at 100° C.;
B) cooling said reaction so that in each case the residence time
   i) in the temperature range from the end of the reaction to 130° C. does not exceed 0.5 hour;
   ii) in the temperature range from the end of the reaction to 110° C. does not exceed 1.5 hours;
   iii) in the temperature range from the end of the reaction to 90° C. does not exceed 7.5 hours; and
   iv) in the temperature range from the end of the reaction to 70° C. does not exceed 72 hours;
   wherein unreacted NDI still present after said reaction is not removed;
C) mixing said storage-stable NCO prepolymer, optionally in admixture with other compounds containing isocyanate groups, with a polyol component b) comprising
   b1) compounds reactive to isocyanates,
   b2) water,
   b3) emulsifier,
   b4) catalysts, and
   b5) optionally auxiliary substances and/or additives to form a mixture;
D) casting or spraying said mixture in a mould;
E) closing said mould, wherein said mixture forms a hardened casting elastomer; and
F) removing said hardened casting elastomer from said mould.

Yet another embodiment of the present invention is a cellular polyurethane casting obtained from
a) a storage-stable NCO prepolymer, optionally in admixture with other compounds containing isocyanate groups;
b) a polyol component comprising:
   b1) compounds reactive to isocyanates;
   b2) water;
   b3) emulsifiers;
   b4) catalysts; and
   b5) optionally auxiliary substances and/or additives;
      wherein said cellular polyurethane casting has a CS of less than 10%, as measured after 22 hours at 80° C. and 2 hours at 23° C. at a deformation of 40%.

Yet another embodiment of the present invention is a vehicle damping element comprising a polyurethane casting elastomer produced by the above process.

Another embodiment of the present invention is the above vehicle damping element, wherein said vehicle is an automobile.

Another embodiment of the present invention is the above vehicle damping element, wherein said damping element is selected from the group consisting of auxiliary springs, buffers, transverse linkage bearings, rear axle subframe bearings, stabiliser bearings, longitudinal strut bearings, front strut supports, strut top mounts, shock absorber support bearings, bearings for triangular transverse arms.

Yet another embodiment of the present invention is an emergency rim-mounted wheel comprising a polyurethane casting elastomer produced by the above process.

Yet another embodiment of the present invention is a coating for rolls, wheels and rollers comprising a polyurethane casting elastomer produced by the above process.

### DESCRIPTION OF THE INVENTION

The present invention provides a process for the production of cellular polyurethane casting elastomers, in which
a) storage-stable 1,5-naphthalenediisocyanate (NDI) prepolymers, optionally in admixture with other compounds containing isocyanate groups
   is mixed with a polyol component b) consisting of
b1) compounds reactive to isocyanate
b2) water
b3) emulsifiers
b4) catalysts
b5) optionally auxiliary substances and/or additives
   and this mixture is cast or injected into a mould, the mould is closed, the mixture is hardened (cured), and the hardened moulded part is removed from the mould.

Storage-stable NCO prepolymers based on 1,5-naphthalenediisocyanate (NDI) are those with an NCO content of 2.5 to 6 wt. % and with a viscosity, measured at 100° C., of <5000 mPas, which are produced continuously or batchwise by reacting
A) 1,5-naphthalenediisocyanate (NDI) with
B) polyols with a number average molecular weight of 850 to 3000 g/mole, preferably 900 to 3000 g/mole, particularly preferably 1000 to 3000 g/mole, with viscosities measured at 75° C. of <1500 mPas and with a functionality of 1.95 to 2.15, selected from the group consisting of polyester polyols, poly-ε-caprolactone polyols, polycarbonate polyols, polyether polyols and α-hydro-ω-hydroxy-poly(oxytetra-methylene)polyols in a ratio of NCO to OH groups of 1.55:1 to 2.35:1, preferably 1.60:1 to 2.15:1, particularly preferably 1.70:1 to 2.00:1, at a temperature of 80° C. to 150° C.,
C) wherein auxiliary substances and additives can be used,
   and after the reaction are rapidly cooled corresponding to the aforedescribed cooling regime.

The polyester polyols mentioned under B) are in accordance with the prior art generally produced by polycondensation of one or more polycarboxylic acids, possibly a polycarboxylic acid derivative, with a molar excess of short-chain polyol, possibly polyol mixtures, in which connection catalysts can also be used. Typical short-chain polyols are alkylene diols with 2 to 12 C atoms. Poly-ε-caprolactone polyols are obtained by ring-opening polymerisation of ε-caprolactone using predominantly bifunctional starter molecules, including water. Polycarbonate polyols are compounds containing hydroxyl terminal groups and on average at least three carbonate groups, which are obtained by synthesis routes known to the person skilled in the art, for example by polycondensation of e.g. phosgene, diphenyl carbonate or dimethyl carbonate with at least one alkylene diol with 2 to 12, preferably 4 to 12 C atoms. Polyether polyols are predominantly polypropylene oxides or polypropylene/co-ethylene oxides polymerised with bifunctional starter compounds, which are obtained for example by catalysis with alkali hydroxides or double metal complexes. α-hydro-ω-hydroxy-poly(oxytetramethylene) polyols are obtained by ring-opening polymerisation of tetrahydrofuran with the aid of highly acidic catalysts. The polyols are normally stabilised with acids.

The production of the NDI prepolymers is carried out by heating the polyol to a temperature of 80° to 150° C. and stirring with NDI. The exact starting temperature for the prepolymer formation depends in this connection on the size of the batch as well as the type of vessel, and is determined in preliminary experiments so that, as a result of the exothermy of the reaction, a temperature maximum is reached that is sufficient to melt the employed NDI in the reaction mixture and obtain a clear homogeneous melt. When using 1,5-NDI the necessary temperature maximum is roughly in the range from 120° to 135° C., particularly preferably 125° to 130° C. After a clear, homogeneous melt has been obtained (end of the reaction) the resultant NCO prepolymers can directly be reacted further, or advantageously for the purposes of a subsequent further working-up can be cooled rapidly to below 70° C., kept in storage or transporting containers, and then stored at room temperature for further use. Rapid cooling (from the temperature at the end of the reaction) to below 70° C. means the following in connection with the process:
i) maximum residence time of 0.5 hour in the temperature range from the end of the reaction up to a temperature of 130° C. and
ii) maximum residence time of 1.5 hours in the temperature range from the end of the reaction up to a temperature of 110° C. and
iii) maximum residence time of 7.5 hours in the temperature range from the end of the reaction up to a temperature of 90° C. and
iv) maximum residence time of 72 hours in the temperature range from the end of the reaction up to a temperature of below 70° C.

The above specified times and temperatures are obviously technically easier to maintain the smaller the amount of NCO prepolymers to be rapidly cooled. On a laboratory scale, i.e. with amounts of up to ca. 10 kg, cooling with air or possibly with liquid media, such as for example water or oil baths, is sufficient for this purpose, whereas on an industrial scale, i.e. with amounts of for example 100 kg or 5 tonnes, effective heat exchanger systems as well as the generally less cost-intensive variant of discharging the hot reaction product into older, already cooled material while intensively stirring or pumping, are suitable. The already cooled material is in this case contained in a stirred vessel and its temperature is chosen depending on the quantitative ratio of new material to old material, so that the temperature of the mixture after the end of the discharge step is at most 100° C. The discharge procedure per se must in this connection be carried out in such a way that for all portions of old and new product all boundary conditions as regards the cooling rate can be observed. The thereby obtained mixture of old and new product quenched to a temperature of at most 100° C. is then cooled further, if necessary by cooling the vessel, to temperatures of below 70° C. In this phase of the process the procedure involving the filling of storage vessels is carried out in parallel to an extent that on the one hand ensures that sufficient product remains in the discharge vessel at a temperature which permits the quenching of the next partial batch to the aforementioned temperature, and on the other hand minimises overall the temperature stress.

To produce larger amounts it is however often more favourable, i.e. simpler and more cost-effective, to carry out the production not in a batchwise manner in reaction vessels, but in a continuous manner by means of reaction extruders.

A further variant of the process therefore involves carrying out the process for the production of the storage-stable NCO prepolymers continuously in reaction extruders. The reaction mixture of polyol and NDI is heated in a first zone of the extruder to temperatures of at least 180° C. up to at most 240° C., and in the following zones of the extruder the reaction mixture is cooled rapidly to temperatures of preferably below 100° C., particularly preferably below 80° C., while applying a reduced pressure to effect a significant degassing and by means of cooling. The melt obtained is added to vessels filled with inert gas and stored. When using the extruder variant an anti-ageing agent is conveniently added to the polyol mixture.

The maintenance of the conditions defined above for the cooling regime should obviously be maintained relatively easily when using a reaction extruder, by suitably adjusting the temperatures in the individual heating and cooling zones as well as the throughput.

The polyols that are used to produce the NCO prepolymers are preferably stored at elevated temperature in a storage vessel before they are used. In this connection it has proved advantageous to store the polyester polyols in the temperature range from 100° to 140° C. and to store the polyether polyols at temperatures from 80° to 120° C.

The storage-stable NDI prepolymers furthermore have the advantage that the unreacted NDI still present after the conversion reaction is not removed, and is present in amounts of more than 0.3 wt. % and less than 5 wt. %, referred to the prepolymer.

The storage-stable NDI prepolymer is thus prepared separately, and can be used up to 6 months after its production. The storage-stable prepolymers do not exhibit any significant change in the NCO content and no sedimentation of free, unreacted 1,5-NDI over this period.

The production of the casting elastomers (moulded parts) is advantageously carried out at an NCO:OH ratio of 0.85 to 1.20, wherein the heated starting components are mixed and added in an amount corresponding to the desired forming density to a heated, preferably tightly closing mould. The surface temperature of the inner wall of the mould is 750 to 90° C. The moulded parts are hardened after 10 to 60 minutes and can then be removed. The amount of mixture added to the mould is normally calculated so that the resultant moulded bodies have the already mentioned density. The starting components are normally added at a temperature of 30 to 110° C. to the mould. The degree of packing is between 1.1 and 8, preferably between 2 and 6. The cellular elastomers are conveniently produced by a low pressure moulding technique or especially by the reaction injection moulding technique (RIM) in open, preferably closed moulds.

The reaction injection moulding technique is described for example by H. Piechota and H. Rohr in “Integralsehaumstoffe”, Carl Hanser-Verlag, Munich, Vienna 1975; D. J. Prepelka and J. L. Wharton in Journal of Cellular Plastics, March/April 1975, pp. 87 to 98 and U. Knipp in Journal of Cellular Plastics, March/April 1973, pp. 76-84.

Additives such as castor oil or carbodiimides (for example stabaxols from Rheinchemie as hydrolysis protection agent, 2,2′,6,6′-tetraisopropyldiphenylcarbodiimide being a known example) can be added to the polyol as well as to the prepolymer. Water, emulsifiers, catalysts and/or auxiliary substances and/or additives together with the polyol normally make up the polyol component.

In order to improve removal from the mould, the moulds are normally provided with external mould release agents, for example wax-based or silicone-based compounds or aqueous soap solutions. The moulded articles removed from the mould are normally beat treated for 1 to 48 hours at temperatures of 70° to 120° C.

The invention also provides cellular polyurethane casting elastomers and moulded articles obtainable from
a) a storage-stable NCO prepolymer, optionally in admixture with other compounds containing isocyanate groups
b) a polyol component consisting of
b1) compounds reactive to isocyanates
b2) water
b3) emulsifiers
b4) catalysts
b5) optionally auxiliary substances and/or additives
with a CS of <10% (measured after 22 hours at 80° C. and 2 hours at 23° C. at a deformation of 40%).

The starting components can include the following:

As further isocyanates, apart from the 1,5-NDI-prepolymer there can be used generally known (cyclo)aliphatic and/or aromatic polyisocyanates. Particularly suitable are aromatic diisocyanates, preferably 2,2′-, 2,4′- and/or 4,4′-diphenylmethane diisocyanate (MDI), 2,4- and/or 2,6-toluoylene diisocyanate (TDI), 3,3′-dimethyl-diphenyl diisocyanate (TODI), 1,2-diphenylethane diisocyanate, phenylene diisocyanate PPDI) and/or (cyclo)aliphatic isocyanates such as e.g. 1,6-hexamethylene diisocyanate (HDI), 1-isocyanato-3,3,5-trimethyl-5-isocyanatomethylcyclohexane and/or polyisocyanates, such as e.g. polyphenylpolymethylene polyisocyanates. The isocyanates can be used in the form of the pure compound, in mixtures and/or in modified form, for example in the form of uretdiones, isocyanurates, allophanates or biurets, preferably in the form of reaction products containing urethane and isocyanate groups and in the form of 1,5-NDI-pre-polymers and various isocyanate prepolymers. Optionally modified 2,2′-, 2,4′- and/or 4,4′-diphenylmethane diisocyanate (MDI), 2,4- and/or 2,6-toluoylene diisocyanate (TDI) and/or mixtures of these isocyanates are preferably used.

Low molecular weight chain extension agents and/or crosslinking agents with a molecular weight of less than 500, preferably 60 to 499, are used as component b), for example from the group comprising dihydric and/or trihydric alcohols, dihydric to tetrahydric polyoxyalkylene polyols and alkyl-substituted aromatic diimines or mixtures of at least two of the aforementioned chain extension agents and/or crosslinking agents. As (b1) there can for example be used alkane diols with 2 to 12, preferably 2, 4 or 6 carbon atoms, for example ethanediol, 1,3-propanediol, 1,5-pentanediol, 1,6-hexanediol, 1,7-heptanediol, 1,8-octanediol, 1,9-nonanediol, 1,10-decanediol and preferably 1,4-butanediol, dialkylene glycols with 4 to 8 carbon atoms, such as for example diethylene glycol and dipropylene glycol and/or dihydric to tetrahydric polyoxyalkylene polyols. Also suitable however are branched-chain and/or unsaturated alkane diols with normally not more than 12 carbon atoms, such as e.g. 1,2-propanediol, 2-methyl-2,2-dimethyl-propanediol-1,3,2-butyl-2-ethylpropanediol-1,3, butene-2-diol-1,4 and butyne-2-diol-1,4, diesters of terephthalic acid with glycols containing 2 to 4 carbon atoms, such as e.g. terephthalic acid bis-ethylene glycol or butanediol-1,4, hydroxyalkylene ethers of hydroquinone or resorcinol, such as e.g. 1,4-di-(b-hydroxyethyl)-hydroquinone or 1,3-di(b-hydroxyethyl)-resorcinol, alkanolamines with 2 to 12 carbon atoms, such as e.g. ethanolamine, 2-aminopropanol and 3-amino-2,2-dimethylpropanol, N-alkyldialkanolamines, such as e.g. N-methyldiethanolamine and N-ethyldiethanolamine. As higher functional crosslinking agents (b1) there may for example be mentioned trihydric and higher polyhydric alcohols, such as e.g. glycerol, trimethylolpropane, pentaerythritol and trihydroxycyclohexanes, as well as trialkanolamines, such as e.g. triethanolamine. The following may be used as chain extension agents: alkyl-substituted aromatic polyamines with molecular weights of preferably 122 to 400, in particular primary aromatic diamines which have in the ortho position to the amino groups at least one alkyl substituent that reduces the reactivity of the amino group by stearic hindrance, and which are liquid at room temperature. For the production of the moulded articles according to the invention there may be used the technically readily accessible 1,3,5-triethyl-2,4-phenylenediamine, 1-methyl-3,5-diethyl-2,4-phenylenediamine, mixtures of 1-methyl-3,5-diethyl-2,4- and -2,6-phenylenediamines, so-called DETDA, isomeric mixtures of 3,3′-di- or 3,3′,5,5′-tetraalkyl-substituted 4,4′-diaminodiphenylmethanes with 1 to 4 C atoms in the alkyl radical, in particular 3,3′,5,5′-tetraalkyl-substituted 4,4′-diaminodiphenylmethanes containing methyl, ethyl, and isopropyl radicals in bound form, as well as mixtures of the aforementioned tetraalkyl-substituted 4,4′-diaminodiphenylmethanes and DETDA. In order to achieve special mechanical properties it may also be expedient to use the alkyl-substituted aromatic polyamines mixed with the aforementioned low molecular weight polyhydric alcohols, preferably dihydric and/or trihydric alcohols or dialkylene glycols. Preferably however no aromatic diamines are employed. The production of the products according to the invention is thus preferably carried out in the absence of aromatic diamines.

In addition to the aforementioned compounds (b1), polyether polyols, polyester polyols and/or hydroxyl group-containing polycarbonates with a functionality of 2 to 3 and preferably a molecular weight of 60 to 6000, more preferably 500 to 6000 and in particular 800 to 3500 can be used, especially if in the production of the NDI prepolymer only a part of the necessary or desired amount of polyol is employed (so-called “polyol splitting”). Suitable polyester polyols can be produced for example from dicarboxylic acids with 2 to 12 carbon atoms and dihydric alcohols. Suitable dicarboxylic acids are for example aliphatic dicarboxylic acids such as succinic acid, glutaric acid, adipic acid, suberic acid, azelaic acid and sebacic acid, and aromatic dicarboxylic acids such as phthalic acid, isophthalic acid and terephthalic acid. The dicarboxylic acids can be used individually or as mixtures. For the production of the polyester polyols it may possibly be advantageous to use, instead of the carboxylic acid, the corresponding carboxylic acid derivatives such as carboxylic acid esters with 1 to 4 carbon atoms in the alcohol radical, carboxylic acid anhydrides or carboxylic acid chlorides. Examples of dihydric alcohols are glycols with 2 to 16 carbon atoms, preferably 2 to 6 carbon atoms, such as e.g. ethylene glycol, diethylene glycol, butanediol-1,4, pentanediol-1,5, hexanediol-1,6, decanediol-1,10,10 2-methylpropane-1,3-diol, 2,2-dimethylpropanediol-1,3, propanediol-1,3 and dipropylene glycol. Depending on the desired properties the dihydric alcohols can be used alone or optionally as mixtures with one another. As polyester polyols there are preferably used ethanediol polyadipates, 1,4-butanediol polyadipates, ethanediol-butanediol polyadipates, 1,6-hexanediol neopentyl glycol polyadipates, 1,6-hexane-diol-1,4-butanediol polyadipates, 2-methyl-1,3-propanediol-1,4-butanediol polyadipates and/or polycaprolactones. Suitable ester group-containing polyoxyalkylene glycols, basically polyoxytetramethylene glycols, are polycondensates of organic, preferably aliphatic dicarboxylic acids, in particular adipic acid with polyoxymethylene glycols with a number average molecular weight of 162 to 600 and optionally aliphatic diols, in particular butanediol-1,4. Suitable ester group-containing polyoxytetramethylene glycols are likewise those formed from polycondensation with ε-caprolactone. Suitable carbonate group-containing polyoxyalkylene glycols, basically polyoxytetramethylene glycols, are polycondensates of these with alkyl or aryl carbonates or phosgene. Examples are given in DE-A 19535 48 771, page 6, lines 26 to 59.

As emulsifier (b3) there are used for example sulfonated fatty acids as well as further generally known emulsifiers, such as for example polyglycol esters of fatty acids, alkylaryl polyglycol ethers, alkoxylates of fatty acids, preferably polyethylene glycol esters, polypropylene glycol esters, polyethylenepolypropylene glycol esters, ethoxylates and/or propoxylates of linoleic acid, linolenic acid, oleic acid, arachidonic acid, particularly preferably oleic acid ethoxylates. Alternatively polysiloxanes can also be used. Salts of fatty acids with amines, e.g. oleic acid diethylamine, stearic acid diethanolamine, castor oil acid diethanolamine, salts of sulfonic acids, e.g. alkali metal or ammonium salts of dodecylbenzenedisulfonic or dinaphthylmethanedisulfonic acid are likewise preferred.

The sulfonated fatty acids can preferably be used as aqueous solutions, for example as 50% solution. Typical known products are the additives SV and SM from Rheinchemie, and also, as non-aqueous emulsifier, the additive WM from Rheinchemie.

The process for the production of the cellular PUR casting elastomers is carried out in the presence of water. The water acts both as a crosslinking agent with the formation of urea groups, as well as a blowing agent with the formation of carbon dioxide due to the reaction with isocyanate groups. The amounts of water that can conveniently be used are 0.01 to 5 wt. %, preferably 0.3 to 3.0 wt. %, referred to the weight of the component (b). The water can be used completely or partly in the form of the aqueous solutions of the sulfonated fatty acids.

The catalysts (b4) can be added individually or also in admixture with one another. Preferably these are organometallic compounds such as tin(II) salts of organic carboxylic acids, for example tin(II) dioctoate, tin(II) dilaurate, dibutyltin diacetate and dibutyltin dilaurate, and tertiary amines such as tetramethylethylenediamine, N-methylmorpholine, diethylbenzylamine, triethylamine, dimethylcyclohexylamine, diazabicyclooctane, N,N′-dimethylpiperazine, N-methyl,N′-(4-N-dimethylamino)butylpiperazine, N,N,N′,N″,N″-pentamethyldiethylenetriamine or the like. Also suitable as catalysts are: amidines, such as for example 2,3-dimethyl-3,4,5,6-tetrahydropyrimidine, tris-(dialkylaminoalkyl)-s-hexahydrotriazines, in particular tris-(N,N-dimethylamilnopropyl)-s-hexahydrotriazine, tetraalkylammonium hydroxides, such as e.g. tetramethylammonium hydroxide, alkali metal hydroxides, such as e.g. sodium hydroxide, and alkali metal alcoholates, such as e.g. sodium methylate and potassium isopropylate, and also alkali metal salts of long chain fatty acids with 10 to 20 C atoms and optionally side-chain OH groups. Depending on the reactivity to be adjusted, the catalysts (b4) are used in amounts of 0.001 to 0.5 wt. %, referred to the component (a).

Auxiliary substances and additives (b5) can be used in the production according to the invention of the casting elastomers. Such auxiliary substances and additives include for example generally known surface-active substances, hydrolysis protection agents, fillers, antioxidants, cell regulators, flameproofing agents and also colourants. Suitable surface-active substances are compounds that serve to assist the homogenisation of the starting substances and are possibly also suitable for regulating the cell structure. Moreover foam stabilisers can be used, such as for example oxyethylated alkylphenols, oxyethylated fatty alcohols, paraffin oils, castor oil or castor oil acid esters, sulfonated castor oil and ground nut oil, and cell regulators such as paraffins and fatty alcohols. The surface-active substances are normally employed in amounts of 0.01 to 5 parts by weight, referred to 100 parts by weight of the components (b).

The cellular PUR casting elastomers according to the invention, also termed moulded articles, are used as damping elements in vehicle construction, for example in automobile construction, for example as auxiliary springs, buffers, transverse linkage bearings, rear axle subframe bearings, stabiliser bearings, longitudinal strut bearings, front strut supports, strut top mounts, shock absorber support bearings, bearings for triangular transverse arms, and as an emergency rim-mounted wheel, which if the tyre is damaged for example allows the vehicle to run on the cellular elastomer and means that the vehicle can still be driven. The casting elastomers and moulded articles can also be used as a coating/covering for rolls, wheels and rollers.

The invention will be described in more detail with the aid of the following examples.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Employed Starting Compounds

Capa 1: Poly-ε-caprolactone started with neopentyl glycol, with a hydroxyl number of 79 mg KOH/g

Desmodur® 15 (naphthalenediisocyanate) from Bayer MaterialScience AG

Vulkollan® 2001 KS (ethylene-butylene adipate, OH no. 55 mg KOH/g)

### Example 1

### Production of an NDI-Based, Storage-Stable NCO Prepolymer Based on Capa 1

100 parts by weight of a poly-ε-caprolactone started with neopentyl glycol and with an OH number of 79 mg KOH/g was dehydrated and stirred at 127° C. with 28.75 parts by weight of Desmodur® 15. The reaction temperature rose to 139° C. after 11 minutes. The reaction mixture was cooled to 65° C. in 10 minutes. The NCO content was 4.14 wt. %; after 24 hours at 65° C. the NCO content was 4.08%. The prepolymer (viscosity at 100° C.: 1650 mPas) was stored at room temperature.

### Example 2

### Production of a Cellular Casting Elastomer from NDI-Based, Storage-Stable NCO Prepolymer

114.4 parts by weight of the NCO prepolymer from Example 1 stored for 45 days at room temperature were heated to 100° C. and mixed with 1.2 parts by weight of castor oil (mixture A).

Mixture B consists of 10 parts by weight of Vulkollan® 2001 KS, 1.65 parts by weight of additive SV (50% aqueous solution of a fatty acid sulfonate, obtainable from Rheinchemie) and also 0.02 part by weight of cyclohexyldimethylamiine.

100 parts by weight of mixture A (ca. 90° C.) and 10.09 parts by weight of mixture B (ca. 45° C.) are mixed at 1800 r.p.m. in a low pressure machine, poured into closed moulds, and then removed from the moulds. The processing conditions and the measurement results are shown in Table 1.

TABLE 1

| | |
|---|---|
| Mixture (A) [parts by weight] | 100 |
| Mixture (B) [parts by weight] | 10.09 |
| Moulded article | |
| Density | 500 kg/m³ |
| Removal from the mould after | 50 Min |
| Moulding temperature | 90° C. |
| Post-heating temperature | 110° C. |
| Post-heating time | 16 H |
| Mechanical properties | |
| CS 72 h/23° C. 40% deformation based on | 1.6% |
| DIN EN ISO 1856 | |
| CS 22 h/80° C. + 2 h 23° C. 40% deformation based | 4.6% |
| on DIN EN ISO 1856 | |
| Tensile strength DIN EN ISO 1798 | 3.79 MPa |
| Elongation at break DIN EN ISO 1798 | 409% |
| Settling amount | 6% |

Surprisingly the compression set (CS) is extremely low, which means that the moulded articles according to the invention can also be used at high temperatures.

### Measurement of the Compression Set at 80° C.:

The test bodies prestressed by 40% were stored for 22 hours at 80° C. and then cooled in the prestressed state for 2 hours at 23° C. (in a modification of DIN EN ISO 1798, with 18 mm high spacers and test bodies with a base surface area of 40×40 mm² and a height of 30±1 mm).

### Measurement of the Dynamical and Mechanical Properties:

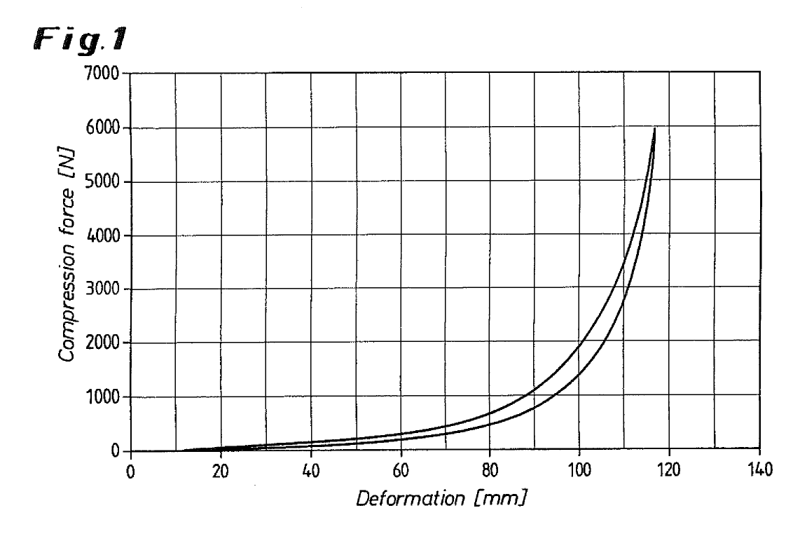

The dynamical and mechanical properties of the test body described above were investigated with the aid of its force deformation curve. For this purpose the moulded article was compressed and stress relieved three times at maximum force to 75% deformation (under the action of a spring). The compression rate was 40 mm/min. The characteristic line was recorded in the third cycle. This gave the spring characteristic 1 (see FIG. 1; first static experiment).

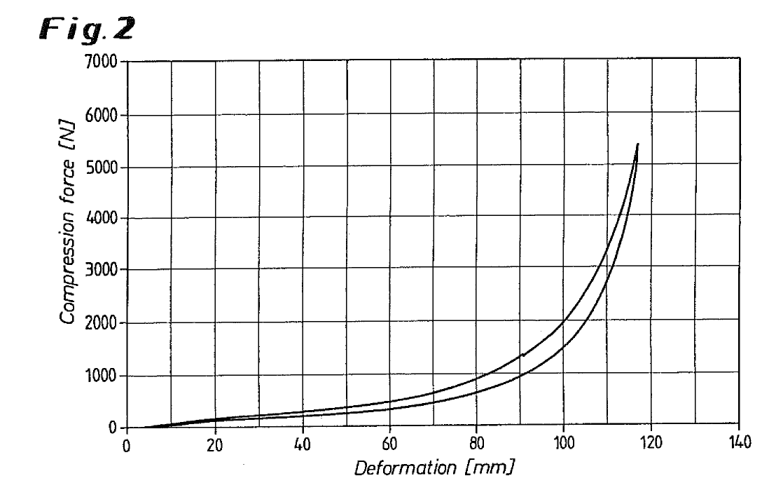

The dynamic testing was then carried out. For this, the moulded article was compressed by 65% and relieved 400,000 times (alternating load). The frequency was 2 Hz. After completion of the test the spring characteristic 2 was recorded (see FIG. 2; second static experiment; implementation similar to spring characteristic 1 with the same clamping height and three cycles).

The spring characteristic is a smooth curve obtained from a plurality of measurement points. The upper curve is the static loading curve and the lower curve is the relaxation curve.

After the dynamical and mechanical testing of the test body the settling amount (SA) was determined according to the following equation

S_{A}=[H₀−Hr)/H₀]×100%

in which H₀ denotes the initial height of the test spring, H_{R} denotes the rest height of the test spring after the second static test, measured after 24 hours storage under normal atmospheric conditions (23° C./50% relative atmospheric humidity). The settling amount is a measure of the permanent deformation of the cellular PU elastomer. The smaller this value, the higher the dynamic efficiency of the material.

The settling amount (with H₀=155.7 and Hr=146.4) has a surprisingly good value of 6

### Example 3

### Comparison

In Comparison Example I from DE 195 34 163 a casting elastomer is produced from a non-storage stable 1,5-NDI prepolymer. The CS is 20% and is thus considerably worse than the CS of the PU casting elastomer produced according to the invention. The settling amount is 8%.

1. A process for producing cellular polyurethane casting elastomers, comprising
A) reacting 1,5-naphthalenediisocyanate (NDI) with a polyol having a number average molecular weight in the range of from 850 to 3000 g/mole, a viscosity of less than 1500 mPas measured at 75° C., and a functionality in the range of from 1.95 to 2.15, and is selected from the group consisting of polyester polyols, poly-ε-caprolactone polyols, polycarbonate polyols, poly-ether polyols, and α-hydro-ω-hydroxy-poly(oxytetramethylene) polyols, in a ratio of NCO groups to OH groups of from 1.55:1 to 2.35:1, continuously or discontinuously at a temperature in the range of from 80° C. to 240° C., optionally in the presence of auxiliary substances and additives, to form a storage-stable NCO prepolymer with an NCO content in the range of from 2.5 to 6 weight % and a viscosity of less than 5000 m-Pas measured at 100
B) cooling said reaction so that in each case the residence time
i) in the temperature range from the end of the reaction to 130° C. does not exceed 0.5 hour;
ii) in the temperature range from the end of the reaction to 110° C. does not exceed 1.5 hours;
iii) in the temperature range from the end of the reaction to 90° C. does not exceed 7.5 hours; and
iv) in the temperature range from the end of the reaction to 70° C. does not exceed 72 hours;
wherein unreacted NDI still present after said reaction is not removed;
C) mixing said storage-stable NCO prepolymer, optionally in admixture with other compounds containing isocyanate groups, with a polyol component b) comprising
b1) compounds reactive to isocyanates,
b2) water,
b3) emulsifier,
b4) catalysts, and
b5) optionally auxiliary substances and/or additives to form a mixture;
D) casting or spraying said mixture in a mould;
E) closing said mould, wherein said mixture forms a hardened casting elastomer; and
F) removing said hardened casting elastomer from said mould.

2. A cellular polyurethane casting obtained from
a) a storage-stable NCO prepolymer, optionally in admixture with other compounds containing isocyanate groups;
b) a polyol component comprising:
b1) compounds reactive to isocyanates;
b2) water;
b3) emulsifiers;
b4) catalysts; and
b5) optionally auxiliary substances and/or additives;
wherein said cellular polyurethane casting has a CS of less than 10%, as measured after 22 hours at 80° C. and 2 hours at 23° C. at a deformation of 40%.

3. A vehicle damping element comprising a polyurethane casting elastomer produced by the process of claim 1.

4. The vehicle damping element of claim 3, wherein said vehicle is an automobile.

5. The vehicle damping element of claim 3, wherein said damping element is selected from the group consisting of auxiliary springs, buffers, transverse linkage bearings, rear axle subframe bearings, stabiliser bearings, longitudinal strut bearings, front strut supports, strut top mounts, shock absorber support bearings, bearings for triangular transverse arms.

6. An emergency rim-mounted wheel comprising a polyurethane casting elastomer produced by the process of claim 1.

7. A coating for rolls, wheels and rollers comprising a polyurethane casting elastomer produced by the process of claim 1.
